(19) United States
(12) Patent Application Publication
(10) Pub. No.: US 2018/0335077 A1
(43) Pub. Date: Nov. 22, 2018

(54) SHAFT AND METHOD FOR MANUFACTURING A SHAFT

(71) Applicant: Rolls-Royce Deutschland Ltd & Co KG, Blankenfelde-Mahlow (DE)

(72) Inventors: Ruediger OESSENICH, Rangsdorf (DE); Magdalena HERRADOR MORENO, Berlin (DE); Thomas ERNSTBERGER, Oederan (DE); Jan EULITZ, Freital (DE)

(21) Appl. No.: 15/982,082

(22) Filed: May 17, 2018

(30) Foreign Application Priority Data
May 18, 2017 (DE) 10 2017 208 424.3

(51) Int. Cl. F16C 3/02

(52) U.S. Cl. CPC F16C 3/026; B29C 70/462; F16C 2360/23; F05D 2240/61

(57) ABSTRACT

A shaft, especially a radial shaft of an aircraft engine, with a hollow shaft made of a fibre composite material in a first multilayered arrangement and connection areas at the respective ends of the shaft for a respective connection element, wherein the connection of shaft and the connection elements is positive locking. The connection areas include a second multilayered arrangement made of fibre composite material, whose layers are arranged on the first multilayered arrangement of the shaft.

### REFERENCE TO RELATED APPLICATION

This application claims priority to German Patent Application No. 10 2017 208 424.3, the entirety of which is incorporated by reference herein.

### BACKGROUND

The invention relates to a shaft and to a method for fabricating the shaft.

Shafts serve for the transmitting of torques, which are introduced into the shaft e.g. by connection elements. In particular, shafts are also constructed from several fibre layers, as is known e.g. from DE 10 2012 022 198 A1 or DE 10 2012 022 260 A1.

A typical application for such a shaft is a radial shaft, which connects an auxiliary equipment support to a shaft across an angle gearbox in an aircraft engine. The flow of energy occurs across the radial shaft in two directions. When starting the engine, a starter (usually operated with pressurized air) which is flanged to the auxiliary equipment support drives the high-pressure shaft of the aircraft engine across the radial shaft. When the aircraft engine is running, power is transferred across the radial shaft from the high-pressure shaft to the auxiliary equipment support, thus driving the auxiliary equipment items located on it (such as fuel pump, oil pressure pump, oil separator, hydraulic pump, generator for the electronic engine control).

### SUMMARY

Due to these loads, shafts and especially radial shafts for aircraft engines need to be compact, robust and at the same time lightweight.

This is guaranteed by a shaft with features as described herein.

For this, the shaft, especially a radial shaft of an aircraft engine, comprises a hollow shaft made of a fibre composite material in a first multilayered arrangement. Connection areas at the respective ends of the shaft serve for receiving a respective connection element, such as one made of metal. The connection of shaft and the connection elements is positive locking and/or non-positive locking. The connection areas comprise a second multilayered arrangement made of fibre composite material, whose layers of fibre material are arranged on the first multilayered arrangement of the shaft.

The fabrication of the shaft is simplified by the separate partitioning into two multilayered arrangements. It is also possible to arrange the shafts in the available, usually modest construction space.

The second multilayered arrangement may have a winding of fibre material, which can be put in place for example after the fabricating of the second multilayered arrangement. In addition or alternatively, the shaft may also have a prefabricated wound structural element, especially one in the form of a fibre ring. The fibre ring may be separately wound, infiltrated and cured, for example.

The first multilayered arrangement in one embodiment may have between 6 and 20 layers of fibre material, especially 12 layers of fibre material, and/or in a second multilayered arrangement have between 3 and 10, especially 6 layers of fibre material.

The first multilayered arrangement in one embodiment has at least one layer of fibre material with a winding angle of absolutely more than 10° and less than absolutely 89° relative to the centre axis of the shaft. By the choice of the winding angle, the resistance to torsion and bending can be specifically influenced. Slanting windings have a greater torsion resistance than flat windings. Flat winding angles have a greater resistance to bending of the overall shaft.

In one embodiment, the winding angles in at least one portion of the layers of fibre material of the first multilayered arrangement change in constant amounts with respect to the centre axis of the shaft. This means that a series of adjacent layers of the first multilayered arrangement differ from each other each time by a constant winding angle magnitude.

In another embodiment, the winding angles in at least one portion of the layers of fibre material of the first multilayered arrangement alternate by a predefined pattern with respect to the centre axis of the shaft, especially by a relatively larger winding angle and a minimal winding angle.

In particular, the absolute magnitude of the winding angle with respect to the centre axis of the shaft in at least one portion of the layers of fibre material of the first multilayered arrangement may be 11°, 27°, 29°, 31°, 34°, 36°, 38° and/or 42°, i.e., a winding angle may be, e.g., +/−11°.

In another embodiment, the second multilayered arrangement has at least one layer of fibre material in which the absolute magnitude of the winding angle with respect to the centre axis of the shaft is between 80° and 90°, especially 87°.

Moreover, in one embodiment at least two adjacent layers of the multilayered arrangements can have different winding angles.

Thanks to the use of different winding angles in the multilayered arrangement, a good infiltration with resin is achieved during the fabrication of the shaft.

The connection elements serve for introducing torques into the shaft and diverting torques out from the shaft. For this, the connection areas in one embodiment have on the inside, especially in the first multilayered arrangement, a sinusoidal cross section shape for the forming of the positive locking with the connection elements. Thus, a regular (wave-shaped) structure is produced on the inside, which may interact with a corresponding contour of the connection elements.

In another embodiment, a middle piece of the shaft between the connection elements has a sinusoidal cross section entirely or for a section. Thus, the sinusoidal structure of the wall may extend not only onto the end regions of the shaft, but may also be arranged on the entire length of the shaft. In this way, a manufacturing technology improvement may be achieved under certain circumstances as compared to a circular cross section.

In order to produce the composite material for the shaft, the layers of the multilayered arrangements are wound, infiltrated with resin in a mould, and cured. In particular, gaps between the multilayered arrangements in the connection areas serve specifically for the holding of resin. These gaps may be filled up especially when using a sinusoidal cross section of the inner, first multilayered arrangement.

In another embodiment, an adhesive connection is present between the connection elements and the first multilayered arrangement in the connection areas at least in partial regions. This can produce, besides the positive locking, also an integral bonding. Loctite 648, for example, may serve as the adhesive. This adhesive is cured anaerobically at room temperature.

The layers of the multilayered arrangements may also consist at least partially of different materials. In this way, a specific adaptation to particular loading conditions can be achieved.

For better guiding during the assembly process, in one embodiment at least one protrusion in the radial direction is arranged on the circumference of the connection elements for engaging with an indentation on the inside of the first multilayered arrangement. In one embodiment, the materials are chosen such that, at temperatures above room temperature the at least one protrusion penetrates by virtue of thermal expansion into the inside of the first multilayered arrangement and at temperatures below room temperature a gap is formed between the at least one protrusion and the inside of the first multilayered arrangement.

The problem is also solved by a method with features as described herein.

In this method, a first multilayered arrangement is first wound as part of the shaft. Then a second multilayered arrangement is arranged on the first multilayered arrangement respectively at the ends of the shaft in connection areas for connection elements.

Thus, at least one of the second multilayered arrangements can be wound by fibres or put in place as a prefabricated fibre ring. In this way, the second multilayered arrangements may be formed the same or different at the ends of the shaft. The use of prefabricated fibre rings simplifies the assembly process.

In particular, at least one metallic connection element may have a predetermined excess, especially in the area of the teeth, the area, especially in the area of the teeth, being hardened by carburizing, and a further abrasive and/or hardening machining step is then performed.

The excess as a geometry factor is chosen to be so large that the deformations due to heat treatment (e.g., after the hardening) can be compensated in particular.

### BRIEF DESCRIPTION OF THE DRAWINGS

The invention shall be explained in connection with the exemplary embodiments represented in the figures.

FIG. 1 shows a simplified cross section view through a first embodiment of a shaft.

FIG. 2 shows a cross section view through a first connection element along line C-C in FIG. 1.

FIG. 3 shows a cross section view through a second connection element along line D-D of FIG. 1.

FIG. 4 shows a first cross section view through the wall of the shaft arrangement in the middle piece at detail E in FIG. 1.

FIG. 5 shows a second cross section view through the wall of the shaft arrangement in the middle piece at detail F in FIG. 1.

FIG. 6 shows a third cross section view through the wall of the shaft arrangement in the middle piece at detail G in FIG. 1.

FIG. 7 shows a simplified cross section view through a second embodiment of a shaft with connection elements.

FIG. 8 shows a view looking at the end face of one of the connection elements per FIG. 7.

FIG. 9 shows a simplified end view of one embodiment of a shaft and a connection element with a protrusion for guidance during the assembly process.

FIG. 10 shows an alternative to the embodiment of FIG. 9.

FIG. 11 shows a further alternative to the embodiment of FIG. 9.

FIG. 12 shows a detail representation for the machining of teeth of a connection element.

### DETAILED DESCRIPTION

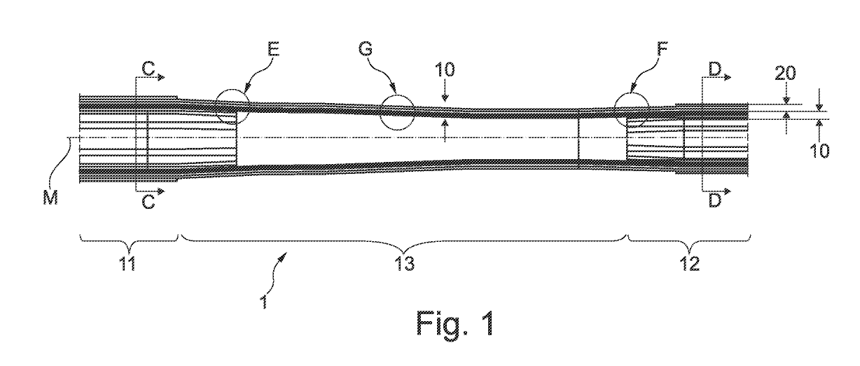

FIG. 1 shows one embodiment of a shaft 1 in a fibre composite design. Such shafts 1 are used, e.g., as radial shafts in aircraft engines. Such radial shafts have, e.g., lengths between 200 and 600 mm, especially between 300 and 500 mm. The outer diameters of such radial shafts may be between 25 and 50 mm. The walls of the shaft 1, which are formed by fibre layers, here carbon fibre bands, typically have thicknesses between 2 and 10 mm, while the walls have different thicknesses at different locations of the shaft 1—as shall be further explained presently. In alternative embodiments, other dimensions may be used for the lengths, diameters, and/or wall thicknesses. The use of such shafts is also possible in internal combustion engines or other machines in which torques need to be transmitted.

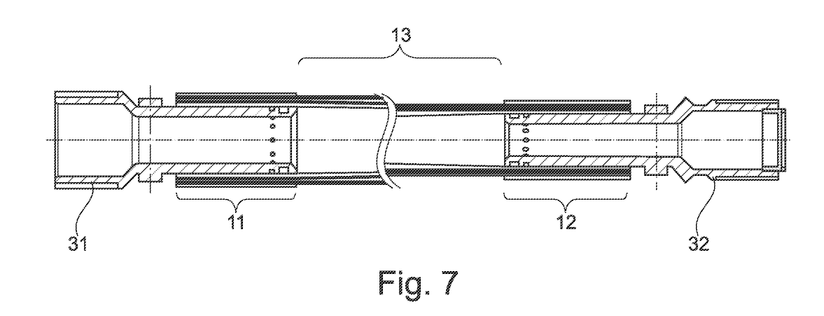

The shaft 1 has a middle piece 13, at whose respective ends are arranged connection areas 11, 12. The connection areas 11, 12 serve for the positive locking to connection elements 31, 32 (see FIG. 7), not represented here. The middle piece 13 of the shaft 1 has conical sections here, but basically may also have cross sections of other shape. Thus, it is also entirely possible for the cross section of the shaft to be sinusoidal.

The shaft 1, being a hollow shaft, has a first continuous multilayered arrangement 10, i.e., a succession of wound fibre layers, the fibre layers generally having different winding angles.

Then a second multilayered arrangement 20 is arranged on the respective connection areas 11, 12, so that the connection areas 11, 12 have more layers of fibre material than does the middle piece 13.

In the present example, the first multilayered arrangement 10 has twelve fibre layers, the second multifibre arrangement 20 has six fibre layers.

In the embodiment represented here, the layers of the multilayered arrangements 10, 20 differ in their winding direction relative to the centre axis M of the shaft 1. The winding angle may basically have absolute magnitudes between 0° (i.e., parallel to the centre axis M) and less than 90° (i.e., almost perpendicular to the centre axis M). By absolute magnitudes of the winding angles are meant the same sizes of angles with respective different winding directions (such as +/−11°).

In the exemplary embodiment represented here, fibre layers of different materials are used. Typically, fibre layers with the same winding angles can be wound from the same materials.

For example, the following layering of twelve layers may be used for the first multilayered arrangement 10, the layers being listed from inside to outside, as seen from the centre axis:

| Layer | Winding angle relative to centre axis M |
|---|---|
| 1 | +/−42° |
| 2 | +/−38° |
| 3 | +/−36° |
| 4 | +/−34° |
| 5 | +/−11° |
| 6 | +/−31° |
| 7 | +/−11° |
| 8 | +/−29° |
| 9 | +/−11° |
| 10 | +/−27° |
| 11 | +/−11° |
| 12 | +/−11° |

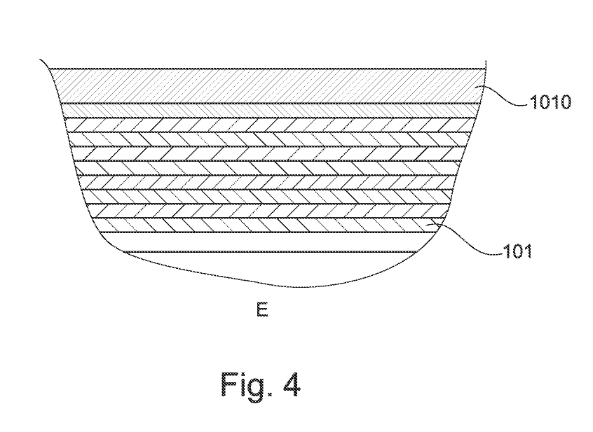

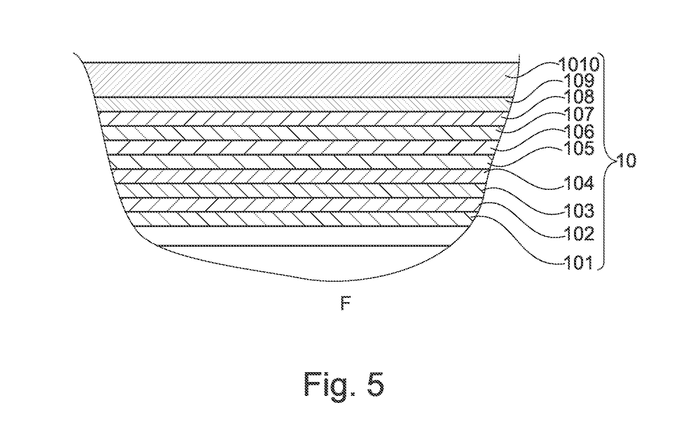

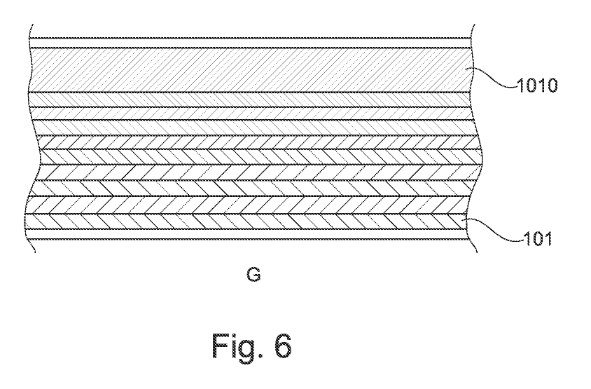

This layering is represented, e.g., in the details E, F and G of FIGS. 4, 5 and 6, different hatching symbolizing different winding angles.

Layers 1 to 4 here have a relatively large winding angle, the winding angles of layers 2 to 4 differing each time by a constant amount of 2°. In layers 5 to 12 there is a different pattern of the winding angles. Layers 6, 8, 10 here have relatively large winding angles in magnitude, the neighbouring layers 5, 7, 9, 11 each having the minimal winding angle of 11°.

The outer layers (No. 10, 11, 12) are represented each time in FIGS. 4, 5 and 6 as a single layer 10₁₀. Other layers from 10₉ to 10₁ then come next.

In FIGS. 4, 5 and 6, one may notice that the same layers are used in the first multilayered arrangement 10 along the shaft 1. The core of the shaft 1 thus consists of the first multilayered arrangement 10.

In FIG. 1 it may also be noticed that the second multilayered arrangement 20 is wound on the first multilayered arrangement 10 in the connection areas 11, 12. This embodiment involves six layers, each of them wound with an offset of +/−87° relative to the centre axis.

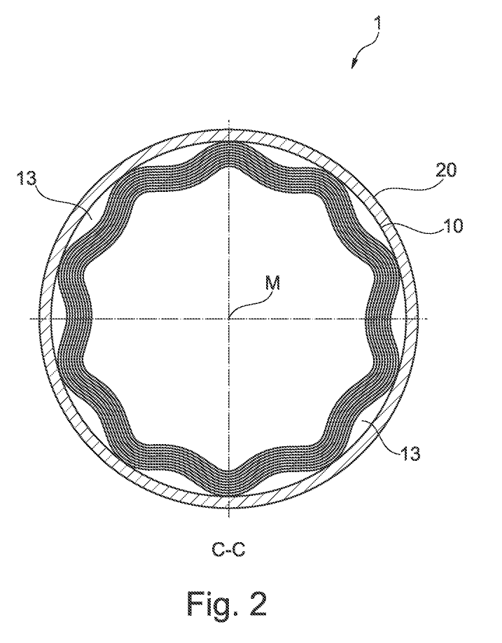

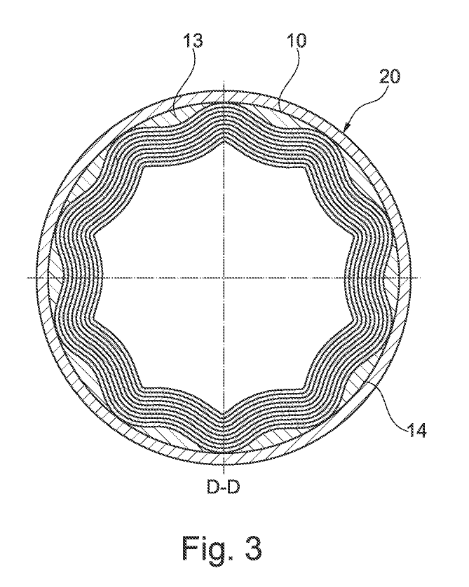

FIG. 2 shows ‘a cross section view along line C-C of FIG. 1, and FIG. 3 shows a cross section view along line D-D of FIG. 1.

The cross section views thus show the areas which receive the connection elements 31, 32, not shown here, with positive locking. For this, the first multilayered arrangement 10 has respective sinusoidal cross section profiles. On the outside, this first multilayered arrangement 10 is surrounded by the layers of the second multilayered arrangement 20. Resin collects specifically in the gaps 14 occurring periodically between the multilayered arrangements 10, 20.

FIG. 7 shows a further embodiment of a shaft 1, but unlike the representation of FIG. 1 the connection elements 31, 32 are installed in the connection areas 11, 12. For this, an adhesive connection with Loctite is used, for example, so that in addition to the positive locking there is an integral bonding.

Also in this embodiment the connection areas 11, 12 of the shaft 1 have more fibre layers than the middle area 13, since the second multilayered arrangement 20 is arranged only at the connection areas 11, 12.

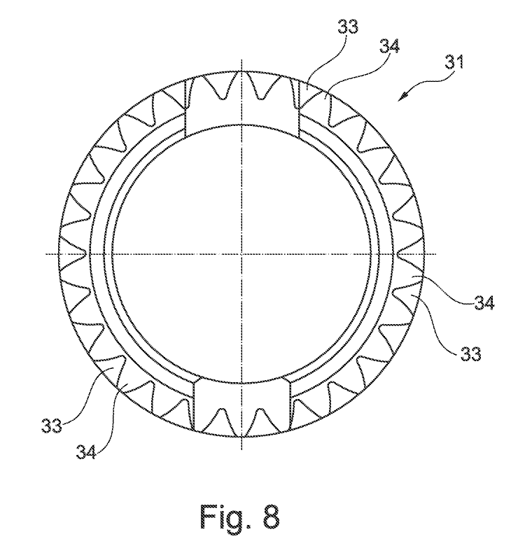

FIG. 8 shows a view of the end face of the second connection element 32. On the circumference of the second connection element 32 there are arranged regular periodic recesses 33 and teeth 34, which may engage with the similarly shaped sinusoidal structure on the inside of the second connection area 12 (see FIG. 2).

The engagement produces a positive locking. The configuration of the first connection element 31 is analogous.

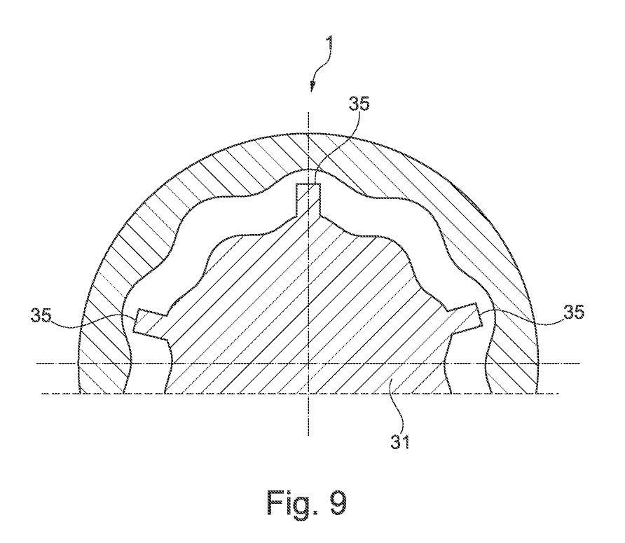

FIG. 9 shows part of a cross section view through one embodiment of the shaft 1 and the interior connection element 31. The layers of the multilayered arrangement 10 here are not shown individually, for better clarity. The inside of the shaft 1 has a sinusoidal contour—for example, like the embodiment of FIG. 2.

In the embodiment of FIG. 9, the metallic connection element 31 has several protrusions 35 on its circumference, which engage radially with the concave indentations of the inside of the shaft 1. The protrusions 35 here may extend lengthwise in the axial direction. Thanks to the engagement of the protrusions, an orientation of the connection element 31 can be accomplished during the mounting in the shaft 1. When the connection element 31 is inserted at room temperature, the protrusion lies against the inside of the wall, i.e., there is no gap. When the temperature is increased, the protrusion 35 penetrates into the inside of the wall. At temperatures below room temperature, a gap is formed.

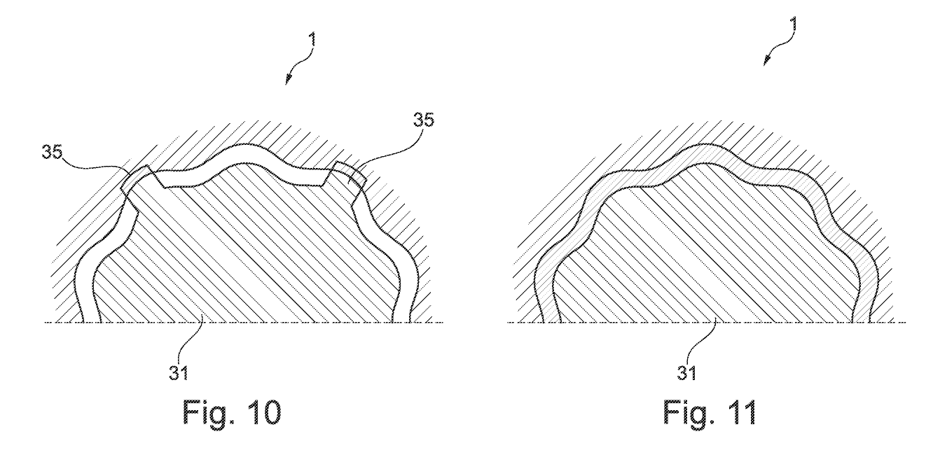

FIG. 10 shows one variation of the embodiment of FIG. 9. The protrusions 35 here are in engagement (press fit) with the sinusoidal structure. The spaces between the sinusoidal structure are then further filled with a material.

FIG. 11 shows another variation. Here, a complete press fit exists under working conditions, i.e., not only at the protrusions 35. An additional material may be introduced into the gap.

In particular in the case of the variants of FIGS. 10 and 11, a press fit is employed between the shaft (made of carbon-fibre plastic) with the sinusoidal inner contour and the metal end piece with sinusoidal outer contour, which exists above the temperature range of −40 to 150° C.

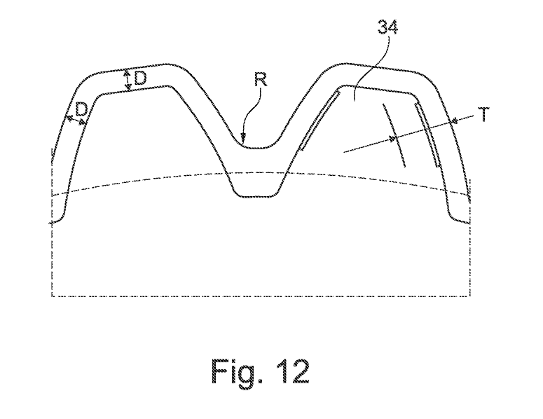

FIG. 12 shows a detail of another embodiment, in which a metallic connection element 31, 32 has a predetermined excess D in the area of the teeth 34. The excess D may be present, e.g., in the range between 0.1 and 0.8 mm, especially 0.4 mm. In relative terms, the excess D may correspond to one fifth to one third of the tooth height. The excess is formed by a layering, which substantially surrounds the teeth 34 with the same thickness overall.

The rounding radius R at the tooth root may be between 0.1 and 0.8 mm, especially 0.4 mm.

In this area, the teeth are at least partly hardened by carburizing. This is represented in FIG. 12 on the right tooth 34 by the thicker lines on the tooth flanks. The depth of hardness T may be between 0.8 and 1.6 mm, especially 1.2 mm.

After this comes a further abrasive and/or hardening machining of the area at the connection element.

### LIST OF REFERENCE NUMBERS

1 Shaft
10 First multilayered arrangement
10₁ . . . 10₁₀ Layers of first multilayered arrangement
11 First connection area
12 Second connection area
13 Middle piece of shaft
14 Gap
20 Second multilayered arrangement
20₁ . . . 20₆ Layers of second multilayered arrangement
31 First connection element
32 Second connection element
33 Recesses
34 Teeth
35 Protrusion
D Excess
M Centre axis of shaft
R Rounding radius
T Depth of hardness

1. A shaft, especially a radial shaft of an aircraft engine, with a hollow shaft made of a fibre composite material in a first multilayered arrangement and connection areas at the respective ends of the shaft for a respective connection element, wherein the connection of shaft and the connection elements is positive locking and/or non-positive locking, wherein the connection areas comprise a second multilayered arrangement made of fibre composite material, whose layers are arranged on the first multilayered arrangement of the shaft.

2. The shaft according to claim 1, wherein the second multilayered arrangement has a winding of a fibre material and/or a prefabricated wound structural element, especially one in the form of a fibre ring.

3. The shaft according to claim 1, further comprising a first multilayered arrangement with between 6 and 20, especially 12 layers of fibre material and/or a second multilayered arrangement with between 3 and 10, especially 6 layers of fibre material.

4. The shaft according to claim 1, wherein the first multilayered arrangement has at least one layer of fibre material with a winding angle of absolutely more than 10° and less than absolutely 89° relative to the centre axis of the shaft.

5. The shaft according to claim 4, wherein the winding angles in at least one portion of the layers of fibre material of the first multilayered arrangement change in constant amounts with respect to the centre axis of the shaft.

6. The shaft according to claim 1, wherein at least one of the following:
the winding angles in at least one portion of the layers of fibre material of the first multilayered arrangement alternate by a definite pattern with respect to the centre axis of the shaft, especially by a larger winding angle and a minimal winding angle, and
the absolute magnitude of the winding angle with respect to the centre axis of the shaft in at least one portion of the layers of fibre material of the first multilayered arrangement is 11°, 27°, 29°, 31°, 34°, 36°, 38° and/or 42°.

7. The shaft according to claim 1, wherein the second multilayered arrangement has at least one layer of fibre material in which the absolute magnitude of the winding angle with respect to the centre axis of the shaft is between 80° and 90°, especially 87°.

8. The shaft according to claim 1, wherein at least two adjacent layers in the multilayered arrangements have different winding angles.

9. The shaft according to claim 1, wherein the connection areas have on the inside, especially in the first multilayered arrangement, a sinusoidal cross section shape for the forming of the positive locking with the connection elements.

10. The shaft according to claim 1, wherein a middle piece of the shaft between the connection elements has a sinusoidal cross section entirely or for a section.

11. The shaft according to claim 1, wherein at least one of the following:
the layers of the multilayered arrangements are impregnated with a resin and cured, and
gaps between the multilayered arrangements in the connection areas serve specifically for the holding of resin.

12. The shaft according to claim 1, wherein an adhesive connection is present between the connection elements and the first multilayered arrangement in the connection areas at least in partial regions, especially with an adhesive curing at room temperature.

13. The shaft according to claim 1, wherein the layers of the multilayered arrangements consist at least partially of different materials.

14. The shaft according to claim 1, wherein at least one protrusion in the radial direction is arranged on the circumference of the connection elements for engaging with an indentation on the inside of the first multilayered arrangement.

15. The shaft according to claim 14, wherein at temperatures above room temperature the at least one protrusion penetrates into the inside of the first multilayered arrangement and at temperatures below room temperature a gap is formed between the at least one protrusion and the inside of the first multilayered arrangement.

16. An aircraft engine with at least one shaft, especially a radial shaft, according to claim 1.

17. A method for fabricating a shaft, especially according to claim 1, wherein
a) a first multilayered arrangement is wound as part of the shaft,
b) a second multilayered arrangement is arranged on the first multilayered arrangement respectively at the ends of the shaft in connection areas for connection elements.

18. The method according to claim 17, wherein the layers of the multilayered arrangements are impregnated with resin at least after a winding process.

19. The method according to claim 17, wherein at least one of the second multilayered arrangement is wound or put in place as a prefabricated fibre ring.

20. The method according to claim 17, wherein
a) at least one metallic connection element has a predetermined excess, especially in the area of the teeth,
b) in the area, especially in a partial area of the flanks of the teeth, hardening is done by carburizing down to a depth of hardness and
c) a further abrasive and/or hardening machining step is then performed.
